(19) United States
(12) Patent Application Publication
(10) Pub. No.: US 2003/0043691 A1
(43) Pub. Date: Mar. 6, 2003

(54) Mixing machine

(75) Inventor: Eberhard Lipp, Altrip (DE)

Correspondence Address: John S. Egbert, Harrison & Egbert, 412 Main Street, 7th Floor, Houston, TX, 77002, US

(73) Assignee: LIPP Mischtechnik GmbH, Mannheim (DE)

(21) Appl. No.: 10/222,012

(22) Filed: Aug. 15, 2002

(30) Foreign Application Priority Data
Aug. 28, 2001 (DE) 101 41 302.5

(51) Int. Cl. B01F 7/22

(52) U.S. Cl. 366/314; 366/330.1; 366/329.1

(57) ABSTRACT

The invention involves a mixing device for mixing a base material with a liquid using a vertical feeder shaft for the base material and a mixing chamber which is arranged below the feeder shaft and into which the liquid is supplied and in which a mixing tool can be driven in rotation, whereby in the feeder shaft, a propeller rotating around a vertical axis is provided, in which blade elements extending in the radial direction are provided. In order to not cause any clogging in the feeder shaft at the propeller, it is proposed to keep individual segments blade-free all the way through over the entire height of the propeller parallel to the axis, when the propeller is rotating in the circumference direction. In this way, a homogenization of the supplied base material is also achieved.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention involves a mixing device for mixing a base material with a liquid using a vertical feeder shaft for the base material and a mixing chamber which is arranged below the feeder shaft and into which the liquid is supplied and in which a mixing tool can be driven in rotation, whereby in the feeder shaft, a propeller rotating around a vertical axis is provided, on which blade elements extending in the radial direction are provided.

### BACKGROUND OF THE INVENTION

With a device of this type, as is known for example from the patent DE-A-196 29 945, base materials, which can involve especially powdered or grain-like solids, which can also occur as chunks or clods, or which can also involve a paste, can be mixed with liquids.

In the process, the problem arises that liquid from the mixing chamber can spray into the feeder shaft and there it can lead to conglutinations or lumps with the base material and thus to a clogging of the feeder shaft. In order to prevent this, on the lower end of the feeder shaft, a propeller is provided for conveyance into the mixing chamber.

In the patent DE-A-196 29 945, it is described that the propeller rotating around a vertical axis in the feeder shaft is designed in such a manner that it forms either a worm screw conveyor all the way through or is comprised of individual worm screw pieces, which are set on top of each other in the axial direction and are offset from each other in the circumferential direction, so that only axial intermediate spaces are open between them. In the axial direction, however, this propeller comprised of individual screw spiral parts is closed, since the individual screw spiral parts cover and overlap each other.

It has now been discovered that this worm screw conveyor-type propeller tends to cause clogging depending on the consistency of the base material. It can occur that the lumpy or clod-shaped base material adheres in a spiral screw and collects and thus prevents a further conveyance of the base material to the mixing chamber.

### BRIEF SUMMARY OF THE INVENTION

The purpose of the invention presented here is thus to further develop a mixing device as indicated above in such a manner that clogging no longer occurs.

This purpose is achieved according to the invention in that in the propeller rotating in the circumferential direction in the feeder shaft, individual segments are blade-free all the way through over the entire height of the propeller parallel to the axis.

It has been discovered that because of the open spaces of this type, going all the way through the propeller, which are parallel to the axis, clogging is prevented. In particular, an embodiment form of this type also has the additional advantage that the base material is still homogenized by the propeller, which leads to better mixing results during the subsequent mixing with liquid.

In particular, in that the propeller rotates at speeds of over 200 revolutions per minute, preferably even speeds of 300 to 3000 revolutions per minute, it is additionally ensured that liquid splashing up out of the mixing chamber cannot enter into the feeder shaft and cause sticking and clumping of the base material there.

This manner of closing of the feeder shaft off from liquid splashing up out of the mixing chamber is especially achieved if several (especially four) blades at a time are provided on the propeller in a plane arranged perpendicularly to the center axis of the propeller. If necessary, the propeller can also have several corresponding planes with blades connected on top of each other. This increases not only the “sealing capacity” to the bottom but also improves a homogenization of the base material when it is supplied into the mixing chamber.

In the process, however, for several planes with blades lying in them, attention must be paid to the fact that the existing blades are each parallel to a blade of an adjacent plane as seen in the radial direction. In this way, it is ensured in a constructively simple manner that the segments parallel to the axis that are kept blade-free are made all the way through over the entire height of the propeller.

The feeder shaft should preferably closely surround the propeller in the process, for example, with a gap width between the rotating blade ends and the wall of the feeder shaft of less than 5 mm, preferably 0.5 3 mm.

Fundamentally, it is certainly within the context of this invention, if the mixing tool rotates around a vertical axis. Preferably, the mixing tool arranged below the feeder shaft in the mixing chamber can be rotated around a vertical axis. In this process it is advantageous if the feeder shaft is rotationally symmetric and its central axis is aligned with the axis of the mixing tool. Then, the propeller can be mounted especially directly on the upper end of the mixing tool.

The propeller mounted on the upper end of the mixing tool that rotates around a vertical axis has constructive advantages in regard to a simpler mounting capability and an easier driving capability of the propeller.

Advantageously, the blades of the propeller are pitched in the direction of conveyance in order to ensure the supply of base material into the mixing chamber. The feeder shaft itself thus does not have to be entirely cylindrical. The feeder shaft can also be constructed so that it is conically tapering. In this way, for example, fluidizing powder is condensed, so that agglomerates are better broken down.

If the base material is rather sticky, it also has proven to be advantageous to construct the feeder shaft so that it is conically expanding. In this process, such sticky base materials are loosened up.

### BRIEF DESCRIPTION OF THE SEVERAL VIEWS OF THE DRAWINGS

Additional advantages and characteristics of the invention can be ascertained from the following description of embodiment examples. Shown are:

FIG. 1 a partial section side view of a mixing device.

FIG. 2 top view of a feeder shaft.

FIG. 3 an alternative embodiment form of a feeder shaft in a section view.

FIG. 4 an additional embodiment form of the feeder shaft in a section view.

### DETAILED DESCRIPTION OF THE INVENTION

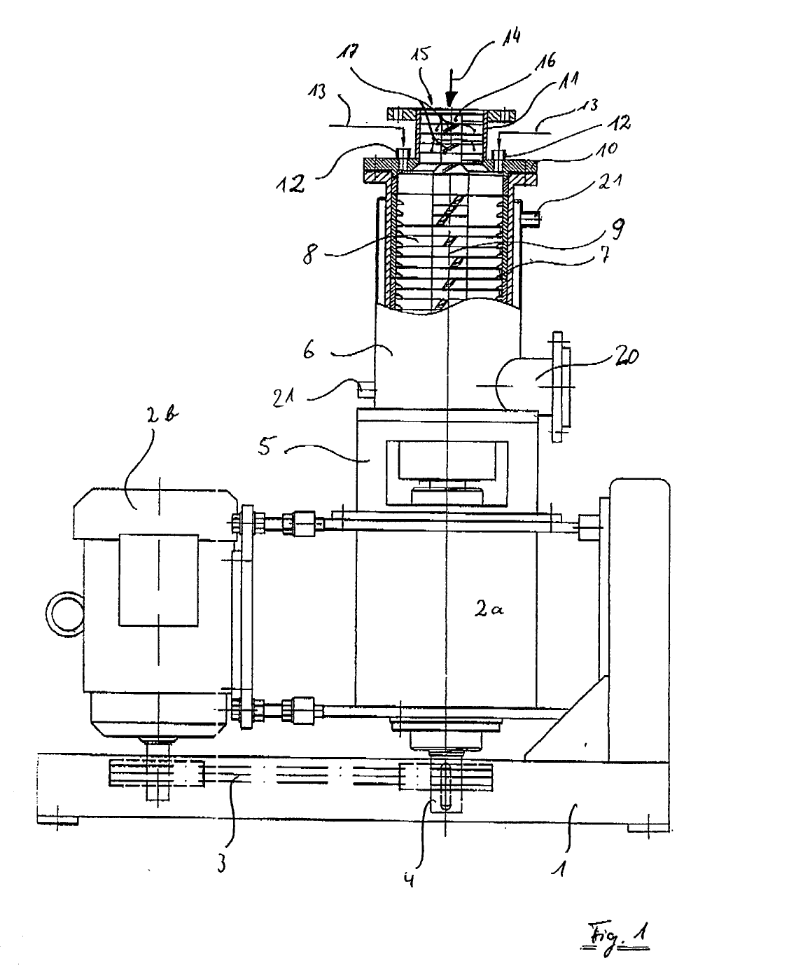

In FIG. 1, the side view of a mixing device can be seen. On a frame stand 1, a shaft bearing 2a is mounted with an electric motor 2b, which is connected via a belt drive 3 to the input shaft 4.

Onto a louver 5, a mixing drum 6 is flange-mounted, in the internal mixing chamber 7 of which a mixing tool 8 can be driven in rotation. The central axis 9 of the mixing tool is oriented in the vertical direction. On the upper end of the mixing chamber 7, a vertical feeder shaft 11 is screwed on via a flange 10. This feeder shaft 11 has a smaller diameter than the mixing chamber 7 arranged below the feeder shaft.

On the flange 10, liquid feeder connections 12 are provided, through which liquid (arrow 13) can be supplied from above into the mixing chamber 7. Through a guide tube (not shown), which is connected on the upper end of the feeder shaft, solid material falls in the same way (arrow 14) coming from above into the feeder shaft 11. This base material is output in the desired quantity through a dosing device (not shown).

Within the feeder shaft 11, a propeller 15 rotates, on which several blades 17 sit on a shaft 16 distributed over the circumference, as can be seen in FIG. 2 in the top view. The blades 17 project in the radial direction until they are close to the inner wall of the feeder shaft 11, which surrounds the propeller, forming a narrow gap. These blades 17 leave open several segments 18 within the feeder shaft 11, which go all the way through and are parallel to the axis. When the propeller 15 is at a standstill, base materials can fall through these segments 18 directly into the mixing chamber 7.

The propeller 15 turns, however, at a speed of greater than 200 rotations per minute (see arrow 19). In this way, base material located in the segments 18 is readily homogenized inside the feeder shaft by the blades 17, before the liquid is added to it in the mixing chamber 7, which is mixed with the base material by the mixing tool 8.

The finished mixture is carried off from the mixing device through a drain connection piece 20. In order to carry off heat occurring during the mixing operation, the mixing chamber 7 can be correspondingly kept at temperature via cold water connections 21.

With regard to the propeller 15 in the feeder shaft, it should also be mentioned that the blades 17 each are arranged in a plane. In addition, in the example shown here it can be recognized that two planes each having four blades 17 arranged in them are arranged over top of each other, such that the corresponding blades 17 lie exactly above each other and, as can be seen, they are slightly pitched. By this pitch, a conveyance of the base material homogenized by the propeller, in the direction to the mixing chamber lying below the propeller, is done.

In addition, in the embodiment example shown here, it can be easily recognized that the propeller is mounted directly onto the mixing tool 8 and thus only one common drive needs to be provided for the mixing tool 8 and propeller 15.

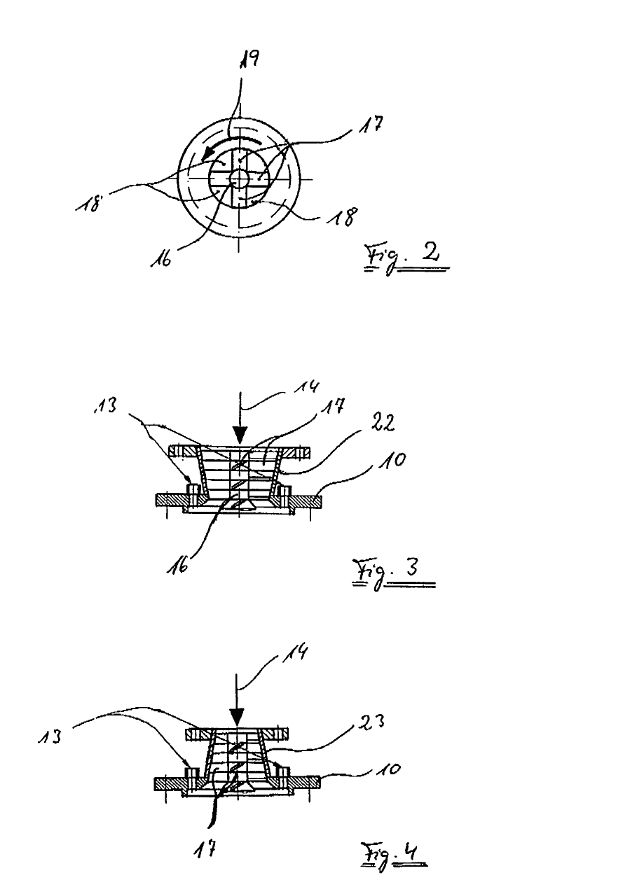

In addition to the embodiment form with a cylindrical feeder shaft 11 as shown in FIG. 1, the feeder shaft can also have a conically tapering shape, as shown in FIG. 3 by reference number 22. In this way, for a base material such as liquidizing powder, it is consolidated, which makes it so that in the feeder shaft 22, agglomerates can be better broken down.

It is also possible, however, as can be recognized in FIG. 4, to construct the feeder shaft (indicated by reference number 23) so that it is conically expanding. In this way, sticky base materials can be loosened up well.

In summary, the invention thus presents a possibility for constructing a mixing device having a vertical orientation, in which a clogging of the feeder shaft is certainly prevented and which also delivers very good mixing results because of a pre-homogenized base material.

I claim:

1. Mixing device for mixing a base material (14) with a liquid (13), having a vertical feeder shaft (11, 22, 23) for the base material (14) and a mixing chamber (7), which is arranged below the feeder shaft (11, 22, 23) and into which the liquid (13) is supplied, and in which a mixing tool (8) can be driven in rotation, whereby in the feeder shaft (11, 22, 23) a propeller (15) rotating around a vertical axis is provided, in which blade elements (17) extending in the radial direction are provided, characterized in that, when the propeller (15) is rotating in the feeder shaft (11, 22, 23) in the circumferential direction, individual segments (18) are blade-free over the entire height of the propeller (15) parallel to the axis.

2. Mixing device according to claim 1, characterized in that, the propeller (15) rotates at a minimum of 200 min-1, preferably at a minimum of 300 to over 3000 min-1.

3. Mixing device according to claim 1, characterized in that, several blades (17) at a time, and preferably four, are provided in a plane arranged perpendicularly to the central axis of the propeller (15).

4. Mixing device according to claim 3, characterized in that, the propeller (15) has several planes with blades (17) that are connected one over top of the other.

5. Mixing device according to claim 4, characterized in that, in each plane, all blades (17) are arranged in the radial direction parallel to a blade (17) of an adjacent plane.

6. Mixing device according to claim 1, characterized in that, the feeder shaft (11, 22, 23) closely surrounds the propeller (15).

7. Mixing device according to claim 1, characterized in that, the mixing tool (8) rotates around a vertical axis (9).

8. Mixing device according to claim 7, characterized in that, the feeder shaft (11, 22, 23) is rotationally symmetric and its central axis is aligned with the axis (9) of the mixing tool (8).

9. Mixing device according to claim 7, characterized in that, the propeller (15) is mounted on the upper end of the mixing tool (8).

10. Mixing device according to claim 1, characterized in that, the blades (17) of the propeller (15) are pitched in the conveyor direction.

11. Mixing device according to claim 1, characterized in that, the feeder shaft (11) is cylindrical.

12. Mixing device according to claim 1, characterized in that, the feeder shaft (22) is conically tapering.

13. Mixing device according to claim 1, characterized in that, the feeder shaft (23) is conically expanding.
